(19) United States
(12) Patent Application Publication
(10) Pub. No.: US 2025/0015492 A1
(43) Pub. Date: Jan. 9, 2025

(54) ANTENNA ASSEMBLY AND COMMUNICATION DEVICE

(71) Applicant: HUAWEI TECHNOLOGIES CO., LTD., Shenzhen (CN)

(72) Inventors: Chao WU, Xi’an (CN); Li JIN, Xi’an (CN); Shaoshuai ZHANG, Xi’an (CN); Enpu WANG, Xi’an (CN)

(21) Appl. No.: 18/891,651

(22) Filed: Sep. 20, 2024

Related U.S. Application Data
(63) Continuation of application No. PCT/CN2023/081031, filed on Mar. 13, 2023.

(30) Foreign Application Priority Data
Mar. 21, 2022 (CN) 202210282021.1

(51) Int. Cl. H01Q 3/12; H01Q 3/32

(52) U.S. Cl. CPC H01Q 3/12; H01Q 3/32

(57) ABSTRACT

An antenna assembly includes at least one element group, a switching assembly and a phase shifter. Each element group of the at least one element group includes at least one radiating element. The switching assembly is communicatively connected to the at least one element group, and is configured to control turning on or off of the at least one element group. The phase shifter is communicatively connected to the switching assembly, and is configured to perform beamforming on the antenna assembly. Roll angles of the antenna assembly are different in response to the switching assembly turning on different element groups of the at least one element group.

### CROSS-REFERENCE TO RELATED APPLICATIONS

This application is a continuation of In International Application No. PCT/CN2023/081031, filed on Mar. 13, 2023, which claims priority to Chinese Patent Application No. 202210282021.1, filed on Mar. 21, 2022, the disclosures of the aforementioned applications are hereby incorporated by reference in their entireties.

### TECHNICAL FIELD

This application relates to the field of communication technologies, and in particular, to an antenna assembly and a communication device.

### BACKGROUND

With rapid development of the communication industry, to meet requirements of people for network service quality and signal coverage, a considerable quantity of mobile antennas need to be mounted. Usually, a clamp part and a rotating assembly are disposed on a mounting bracket of a mobile antenna, and are configured to adjust the antenna. Therefore, a roll angle of the antenna is changed, and further, antenna gain utilization is improved. However, when a roll angle of an existing mobile antenna is adjusted, the roll angle needs to be manually adjusted at heights. Operations are complex, and are dangerous to some extent.

### SUMMARY

One or more embodiments of the present application provide an antenna assembly and a communication device, to reduce difficulty in adjusting a roll angle of the antenna assembly.

In some embodiments, the application provides an antenna assembly. In some embodiments, the antenna assembly includes:
at least one element group, where each element group includes at least one radiating element;
a switching assembly, where the switching assembly is communicatively connected to the element group, and is configured to control on/off of the element group; and
a phase shifter, where the phase shifter is communicatively connected to the switching assembly, and is configured to perform beamforming on the antenna assembly, where
when the switching assembly turns on different element groups, roll angles of the antenna assembly are different.

In some embodiments, the phase shifter and the switching assembly are disposed, so that the switching assembly can turn on or turn off the corresponding element group, and the antenna assembly is beamformed. Therefore, a roll angle in a directivity pattern of the antenna assembly is adjusted, and the roll angle in the directivity pattern of the antenna assembly can be remotely adjusted.

In some embodiments, the antenna assembly includes a plurality of element groups, and each of the element groups is disposed in a length direction and/or a width direction of the antenna assembly.

The element groups are arranged according to a preset rule to form an array. This helps increase a coverage area of the antenna assembly.

In some embodiments, the element groups disposed along a straight line of the length direction of the same antenna assembly form a first radiation structure, and a plurality of first radiation structures are disposed along the width direction of the antenna assembly and spaced from each other.

The plurality of element groups form the first radiation structure, and the plurality of first radiation structures can form an array. This helps increase the coverage area of the antenna assembly.

In some embodiments, there is a preset distance between adjacent first radiation structures along the length direction of the antenna assembly.

Element groups in a same row along the width direction of the antenna assembly may be arranged in a staggered manner, to help improve isolation between co-polarized arrays and improve a front-to-back ratio indicator in a directivity pattern of the array.

In some embodiments, the element groups disposed along a straight line of the width direction of the same antenna assembly form a second radiation structure, and a plurality of second radiation structures are disposed along the length direction of the antenna assembly and spaced from each other.

The plurality of element groups form the second radiation structure, and the plurality of second radiation structures can form an array. This helps increase the coverage area of the antenna assembly.

In some embodiments, there is a preset distance between adjacent second radiation structures along the width direction of the antenna assembly.

Element groups in a same column along the length direction of the antenna assembly may be arranged in a staggered manner, to help converge a horizontal-plane beam width in a directivity pattern of the array, reduce neighboring cell interference, and optimize coverage experience.

In some embodiments, the antenna assembly includes a plurality of switching assemblies, and each of the switching assemblies corresponds to the at least one element group, and is configured to control on/off of the corresponding element group.

The plurality of switching assemblies are disposed, so that on/off of the element group can be more flexible. This helps adjust the roll angle of the antenna assembly.

In some embodiments, the switching assembly is located between adjacent element groups along the length direction or the width direction of the antenna assembly.

In some embodiments, a structure of the antenna assembly may be more compact. In addition, such design helps reduce a transmission distance, and control on/off of the element group.

In some embodiments, the antenna assembly further includes a transmission part and/or a calibration network. The calibration network is communicatively connected to the phase shifter.

In some embodiments, such a design helps adjust an angle of the antenna assembly, and improve signal quality of the antenna assembly.

In some embodiments, the present application further provides a communication device. The communication device includes an antenna assembly.

In some embodiments, the antenna assembly is the antenna assembly according to any one of the foregoing descriptions.

In some embodiments, the present application relates to an antenna assembly and a communication device. The antenna assembly includes a phase shifter, a switching assembly, and at least one element group. Each element group includes at least one radiating element. The switching assembly is communicatively connected to the element group, and can turn on or turn off the corresponding element group. The phase shifter is configured to perform beamforming on the antenna assembly. When different element groups are turned on, roll angles of the antenna assembly are different. According to the solution provided in this application, the roll angle of the antenna assembly can be remotely adjusted. Therefore, a mechanical adjustment structure of the antenna assembly can be omitted, adjustment difficulty can be reduced, and an actual use requirement can be better met.

It should be understood that the foregoing general descriptions and the following detailed descriptions are merely examples, and cannot limit this application.

### BRIEF DESCRIPTION OF DRAWINGS

FIG. 1 is a diagram of a structure of a first embodiment of an antenna assembly according to this application;

FIG. 2 is a simulation diagram of an antenna assembly in a first state according to this application:

FIG. 3 is a simulation diagram of an antenna assembly in a second state according to this application:

FIG. 4 is a simulation diagram of an antenna assembly in a third state according to this application:

FIG. 5 is a simulation diagram of an antenna assembly in a fourth state according to this application:

FIG. 6 is a simulation diagram of an antenna assembly in a fifth state according to this application:

FIG. 7 is a diagram of a structure of a second embodiment of an antenna assembly according to this application:

FIG. 8 is a diagram of a relationship between a level value and an azimuth of embodiments of the antenna assembly shown in FIG. 1 and FIG. 7:

FIG. 9 is a diagram of a structure of a third embodiment of an antenna assembly according to this application:

FIG. 10 is a diagram of a relationship between a level value and an azimuth of embodiments of the antenna assembly shown in FIG. 1 and FIG. 9;

FIG. 11 is a diagram of an internal structure of an antenna assembly according to this application:

FIG. 12 is a diagram of a structure of a communication device according to this application:

FIG. 13 is an on/off diagram of an antenna assembly in a first state according to this application:

FIG. 14 is an on/off diagram of an antenna assembly in a second state according to this application:

FIG. 15 is an on/off diagram of an antenna assembly in a third state according to this application:

FIG. 16 is an on/off diagram of an antenna assembly in a fourth state according to this application; and

FIG. 17 is an on/off diagram of an antenna assembly in a fifth state according to this application.

### REFERENCE NUMERALS

1—antenna assembly, 11—element group, 111—radiating element, 12—switching assembly, 13—phase shifter, 14—first radiation structure, 15—second radiation structure, 16—transmission part, 17—calibration network, 18—reflection plate, 19—radome, 2—mounting part, 3—adjustment bracket, 4—grounding apparatus, 5—sealing member, 6—combiner, and 7—filter.

The accompanying drawings herein are incorporated into this specification and constitute a part of this specification, show embodiments in accordance with this application, and are used together with this specification to explain the principle of this application.

### DETAILED DESCRIPTION

To better understand technical solutions of this application, the following describes embodiments of this application in detail with reference to the accompanying drawings.

With rapid development of the communication industry, to meet requirements of people for network service quality and signal coverage, a considerable quantity of mobile antennas need to be mounted. In a process of using the mobile antenna, to achieve better transmission and reception effects, the mobile antenna is generally mounted at a specific height and fixed via a mounting bracket. Because surrounding buildings cause signal refraction or reflection, there is a significant difference between actual coverage and a coverage requirement, and signal strength varies in different areas. In this case, an angle of the mobile antenna needs to be adjusted, to reduce interference caused by an ambient environment to a signal, reduce disordered reflection of the signal, and optimize a network. Usually, a clamp part and a rotating assembly are disposed on the mounting bracket of the mobile antenna, and the mobile antenna can be rotated by using a mechanical structure. Therefore, a roll angle of the antenna is changed. The roll angle of the antenna is an angle between a horizontal axis of a beam in a directivity pattern of the antenna and a horizontal line. The roll angle of the antenna is changed to adjust a coverage area of the antenna. Therefore, antenna gain utilization is improved. However, when the antenna is adjusted by using the mechanical structure, during actual operation, an operator needs to work at heights, and manually adjust the angle of the antenna. Operations are complex: precision is low because the operations are performed manually; and a capability requirement for the operator is high. In addition, work at heights is dangerous to some extent.

In view of this, embodiments of this application provide an antenna assembly and a communication device, to reduce difficulty in adjusting a roll angle of the antenna assembly.

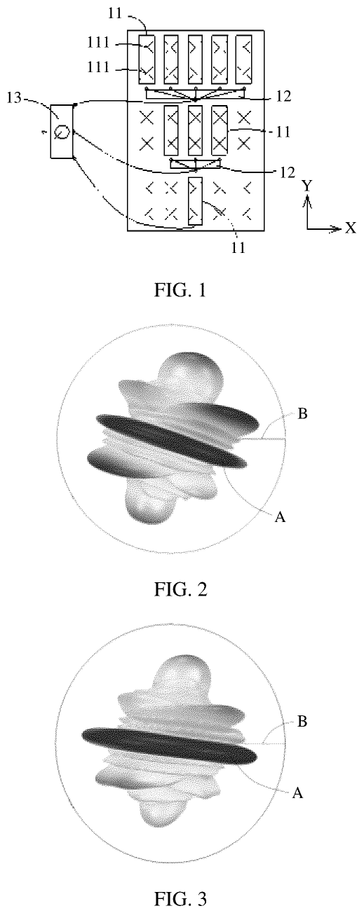

As shown in FIG. 1, an embodiment of this application provides an antenna assembly 1. The antenna assembly 1 includes a phase shifter 13, a switching assembly 12, and at least one element group 11. Each element group 11 includes at least one radiating element 111. The radiating element 111 may be a structure such as an antenna element, and is configured to radiate or receive a radio wave. The switching assembly 12 is communicatively connected to the element group 11, and is configured to control on/off of each element group 11. The phase shifter 13 is communicatively connected to the switching assembly 12, and is configured to perform beamforming on the antenna assembly 1. A control signal received by the switching assembly 12 may be a manually input signal, or may be a signal transferred by another device. To be specific, the switching assembly 12 may be directly manually adjusted to change on/off of the element group 11, or a related parameter may be input to a corresponding device to control the switching assembly 12 via a control unit such as a processor. When the switching assembly 12 changes an on/off state of each element group 11, in other words, when the antenna assembly 1 turns on different element groups 11, roll angles in a directivity pattern of the antenna assembly 1 are different.

Specifically, when different element groups 11 are turned on, a plurality of element groups 11 of the antenna assembly 1 are adjusted simultaneously. Therefore, an element arrangement of the antenna assembly 1 in a vertical direction (which is a direction perpendicular to the ground) is changed, the roll angle is adjusted, and coverage of a beam in the directivity pattern is changed.

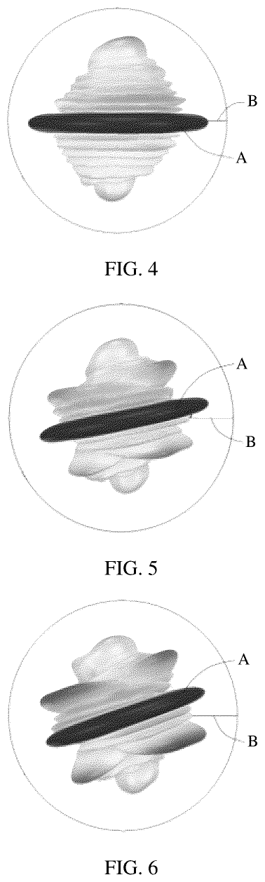

FIG. 2 to FIG. 6 each are a simulation effect diagram in which the antenna assembly 1 turns on a different element group 11 according to an embodiment of this application. A is a horizontal axis of the beam in the directivity pattern, B is a horizontal line, and an angle between the horizontal axis and the horizontal line is the roll angle of the antenna assembly 1 in a corresponding state.

The switching assembly 12 communicatively connected to the element group 11 is disposed to turn on or turn off the corresponding element group 11. Therefore, an array arrangement of the antenna assembly 1 in the vertical direction (which is usually the direction perpendicular to the ground) is adjusted, and the roll angle in the directivity pattern of the antenna assembly 1 is changed. According to the solution provided in this embodiment of this application, the roll angle of the antenna assembly 1 can be adjusted in an electronic regulation manner, and the antenna assembly 1 does not need to be manually rotated. During the adjustment, operations are simpler and more convenient, and adjustment precision is higher. In addition, according to the solution provided in this embodiment of this application, the roll angle of the antenna assembly 1 can be remotely adjusted. During use, the roll angle may be adjusted in real time based on an actual effect. Therefore, this helps optimize a network and improve signal strength. In addition, an operator does not need to work at heights, working danger can be reduced, and an actual use requirement can be better met.

As shown in FIG. 1, in some embodiments, the antenna assembly 1 includes the plurality of element groups 11, and each of the element groups 11 is disposed in a length direction and/or a width direction of the antenna assembly 1.

In some embodiments, the element groups 11 may be arranged according to a preset rule, so that an actual use requirement is better met.

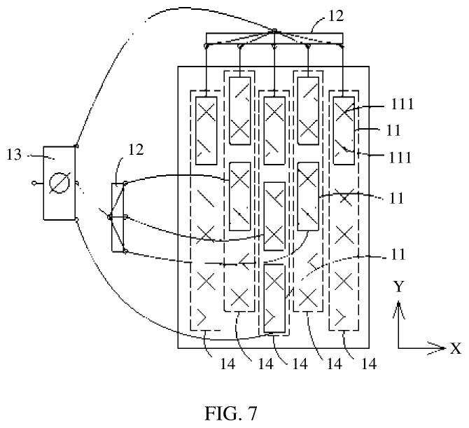

As shown in FIG. 7, in some embodiments, element groups 11 disposed along a straight line of a length direction of the same antenna assembly 1 are configured to form a first radiation structure 14. The element groups 11 in a same dashed line range in the figure form one first radiation structure 14. A plurality of first radiation structures 14 are disposed along the width direction of the antenna assembly 1 and spaced from each other.

Such design facilitates an array arrangement of the element groups 11. The switching assembly 12 controls the corresponding element group 11 to be turned on or turned off, to radiate different areas. Therefore, the roll angle in the directivity pattern of the antenna assembly 1 is changed.

As shown in FIG. 7, in some embodiments, there is a preset distance between adjacent first radiation structures 14 along the length direction of the antenna assembly 1.

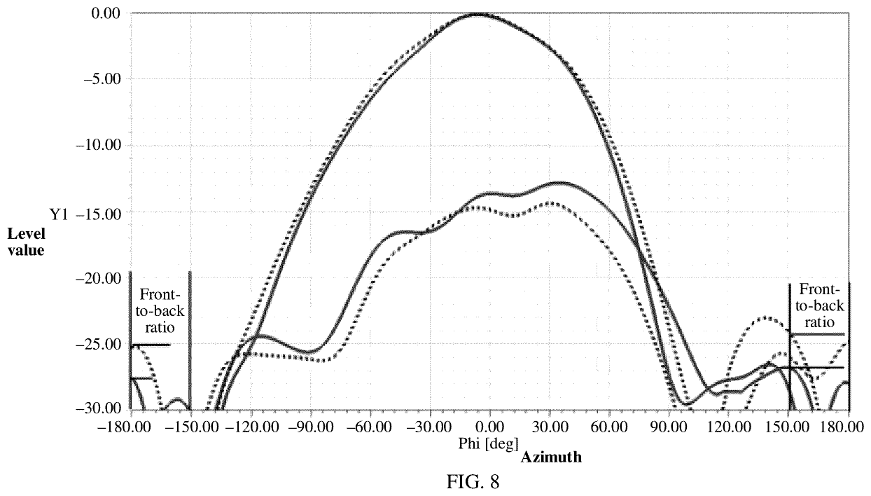

As shown in FIG. 8, a dotted line in the figure is a directivity pattern of an array of the embodiment shown in FIG. 1, and a solid line in the figure is a directivity pattern of an array of the embodiment shown in FIG. 7. In some embodiments, element groups 11 in a same row along the width direction of the antenna assembly 1 may be arranged in a staggered manner, in other words, arranged in a wave-like manner, to help improve isolation between co-polarized arrays, improve a front-to-back ratio indicator in the directivity pattern of the array, and improve a capability of the antenna assembly 1 to suppress backward interference.

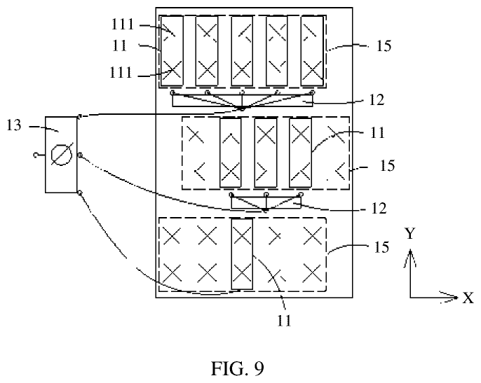

As shown in FIG. 9, in some embodiments, element groups 11 disposed along a straight line of a width direction of the same antenna assembly 1 form a second radiation structure 15. The element groups 11 in a same dashed line range in the figure form one second radiation structure 15. A plurality of second radiation structures 15 are disposed along the length direction of the antenna assembly 1 and spaced from each other.

Such design facilitates an array arrangement of the element groups 11. The switching assembly 12 controls the corresponding element group 11 to be turned on or turned off, to radiate different areas. Therefore, the roll angle in the directivity pattern of the antenna assembly 1 is changed.

As shown in FIG. 9, in some embodiments, there is a preset distance between adjacent second radiation structures 15 along the width direction of the antenna.

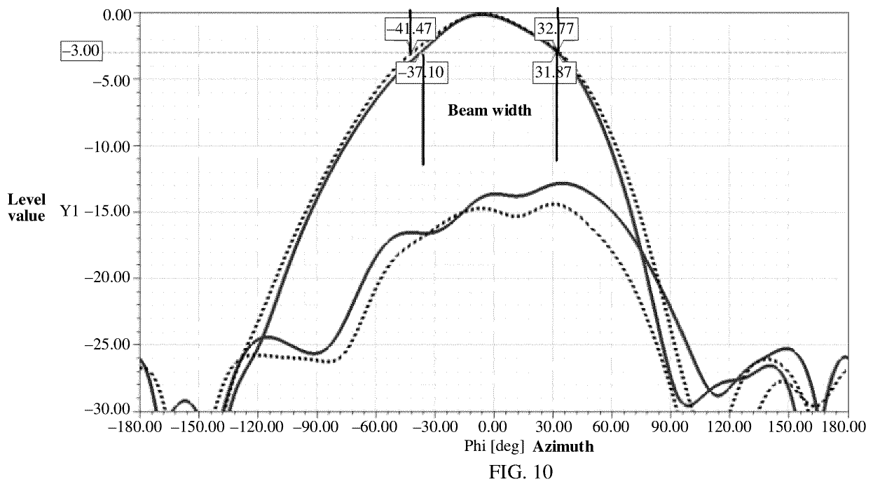

As shown in FIG. 10, a dotted line in the figure is a directivity pattern of an array of the embodiment shown in FIG. 1, and a solid line in the figure is a directivity pattern of an array of the embodiment shown in FIG. 9. In some embodiments, element groups 11 in a same column along the length direction of the antenna assembly 1 may be arranged in a staggered manner, in other words, arranged in a wave-like manner, to help converge a horizontal-plane beam width in the directivity pattern of the array, reduce neighboring cell interference, and optimize coverage experience.

As shown in FIG. 1, in some embodiments, the antenna assembly 1 may include a plurality of switching assemblies 12. Each of the switching assemblies 12 corresponds to the at least one element group 11, to control on/off of the corresponding element group 11. Specifically, the switching assembly 12 may be a multi-pole multi-throw switch.

The plurality of switching assemblies 12 are disposed, so that an on/off combination of the element groups 11 can be more flexible, the operator can adjust on/off of the element groups 11 to corresponding states based on actual requirements, and the roll angle in the directivity pattern of the antenna assembly 1 is further adjusted to a preset value. Therefore, performance of the antenna assembly 1 is improved.

As shown in FIG. 1, in some embodiments, the switching assembly 12 is located between adjacent element groups 11 along the length direction or the width direction of the antenna assembly 1. Specifically, the switching assembly 12 may be disposed on a substrate for mounting the element groups 11.

The switching assembly 12 is disposed between the adjacent element groups 11, so that a distance between the switching assembly 12 and the element group 11 can be shortened. This facilitates transfer of the control signal. When a connection is performed by using a connection line, a length of the connection line can be effectively shortened, a possibility of winding between connection lines can be reduced, and further, costs can be reduced. In addition, the switching assembly 12 is disposed between the adjacent element groups 11, so that an overall structure of the antenna assembly 1 can be more compact. This facilitates a miniaturization design of the antenna assembly 1, space for mounting is reduced, and an actual use requirement is better met.

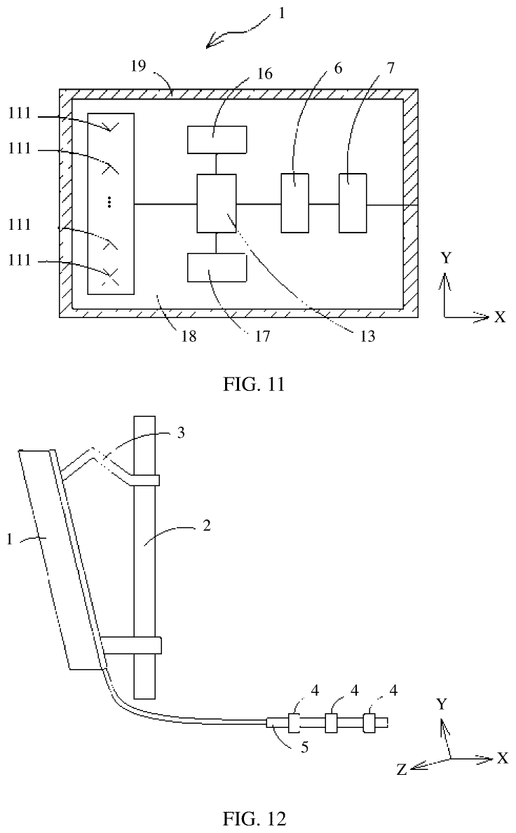

As shown in FIG. 11, in some embodiments, the antenna assembly 1 may further include a transmission part 16 and/or a calibration network 17. The calibration network 17 can be communicatively connected to the phase shifter 13. The calibration network 17 is configured to calibrate a radio frequency signal. The transmission part 16 may include a driving structure such as a motor, where the driving structure may be configured to drive the antenna assembly 1 to move, to adjust a position of the antenna assembly 1. The transmission part 16 and the calibration network 17 may be disposed based on actual requirements. Neither of the transmission part 16 and the calibration network 17 may be disposed, either of the transmission part 16 and the calibration network 17 may be disposed, or both of the transmission part 16 and the calibration network 17 may be disposed.

As shown in FIG. 11, the antenna assembly 1 may further include a reflection plate 18, a feed network, a radome 19, and other parts. The radiating element 111 may be disposed on the reflection plate 18. The radiating element 111 is also referred to as an antenna element, an element, or the like, and can effectively radiate or receive a radio wave, to transmit or transfer a signal. The reflection plate 18 is also referred to as a bottom panel, an antenna panel, a metal reflective surface, or the like, and is configured to improve receiver sensitivity of an antenna signal. The reflection plate 18 can reflect and aggregate the antenna signal at a receiving point. This helps enhance capabilities of the antenna assembly 1 to receive and transmit the signal. In addition, the reflection plate 18 can also play a role of signal shielding, and may be configured to shield a signal on a side that is of the reflection plate 18 and that is away from the radiating element 111, to reduce interference caused by another electric wave to signal receiving of the antenna assembly 1. The feed network is configured to feed the signal to the radiating element 111 based on a specific amplitude and phase, or send a received radio signal to a signal processing unit of a base station based on a specific amplitude and phase. Usually, the feed network includes a controlled impedance transmission line, and may include the phase shifter 13, a combiner 6, a filter 7, and other components. The radome 19 is configured to protect the antenna assembly 1, and reduce impact of an external environment on the performance of the antenna assembly 1, for example, may play waterproof and dustproof roles. In addition, the radome 19 further has a good electromagnetic wave penetration characteristic, to reduce impact on signal propagation.

Based on the antenna assembly 1 provided in the foregoing embodiments, an embodiment of this application further provides a communication device. The communication device includes an antenna assembly 1. The antenna assembly 1 is configured to receive or transmit a signal. The antenna assembly 1 may be the antenna assembly 1 in any one of the foregoing embodiments. Because the antenna assembly 1 has the foregoing technical effects, the communication device including the antenna assembly 1 also has corresponding technical effects. Details are not described herein again.

As shown in FIG. 12, the antenna assembly 1 may be mounted on a mounting part 2. The mounting part 2 may be a structure such as a pole or a mounting post. The antenna assembly 1 may be mounted on the mounting part 2 via an adjustment bracket 3. The adjustment bracket 3 may adjust a position of the antenna assembly 1 to adjust a radiation area of the antenna assembly 1, so that signal strength of a corresponding area is adjusted. A connector of the antenna assembly 1 may be connected to a grounding apparatus 4 to improve an anti-interference capability of the antenna assembly 1, and may also play a role such as surge protection, to improve security of the antenna assembly 1. A sealing member 5 may be disposed in a structure of the antenna assembly 1. The sealing member 5 may be an insulation sealing tape, a polyvinyl chloride (PVC) insulation tape, or the like.

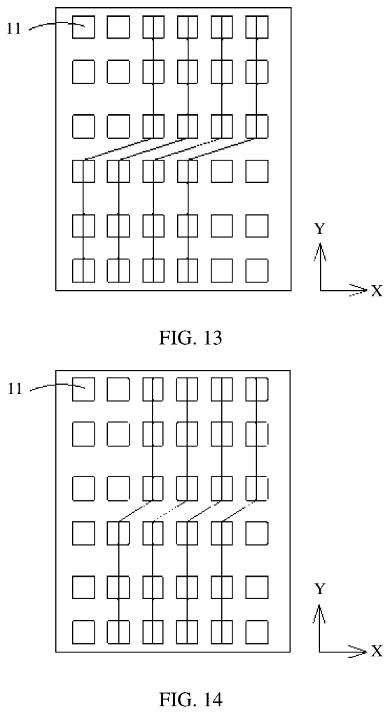

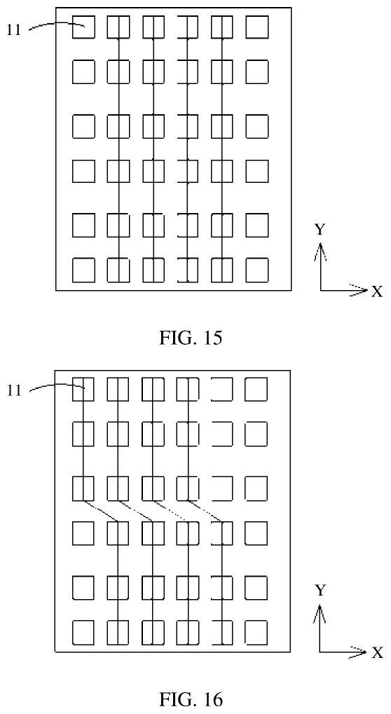

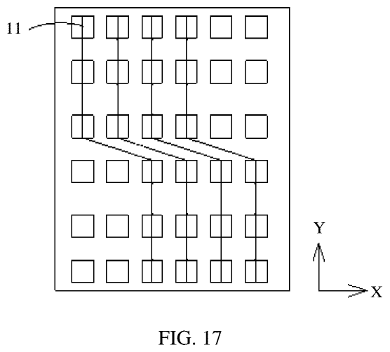

As shown in FIG. 13 to FIG. 17, an antenna assembly 1 may control, through switching of a switching assembly 12, different element groups 11 to work, to form antenna arrays with different roll angles. In some embodiments, the element groups 11 are turned on in manners shown in FIG. 13 to FIG. 17, and obtained roll angles are −Δ2Φ, −ΔΦ, 0°, ΔΦ, and Δ2Φ respectively. Simulation diagrams of FIG. 13 to FIG. 17 sequentially correspond to those of FIG. 2 to FIG. 6. Φ may be selected based on actual requirements.

It should be noted herein that the foregoing solution is merely a roll angle obtained in a specific application scenario of the solution provided in this embodiment of this application. During actual use, angles of the roll angle of the antenna assembly 1 include but are not limited to −Δ2Φ, −ΔΦ, 0°, ΔΦ, and Δ2Φ.

Based on the antenna assembly 1 provided in the foregoing embodiments, an embodiment of this application further provides a communication device. The communication device includes an antenna assembly 1. The antenna assembly 1 is configured to receive or transmit a signal. The antenna assembly 1 may be the antenna assembly 1 in any one of the foregoing embodiments. Because the antenna assembly 1 has the foregoing technical effects, the communication device including the antenna assembly 1 also has corresponding technical effects. Details are not described herein again.

The antenna assembly 1 and the communication device provided in embodiments of this application may be used in a scenario such as a high-speed railway. A roll angle of the antenna assembly 1 is adjusted, to change a radiation direction of the antenna assembly 1. Therefore, a projection, on a bottom surface, of a maximum gain radiation surface in an antenna directivity pattern overlaps the high-speed railway. In other words, this helps increase a signal coverage area, to improve antenna gain utilization.

Embodiments of this application provide an antenna assembly 1 and a communication device. The antenna assembly 1 includes a phase shifter 13, a switching assembly 12, and at least one element group 11. Each element group 11 includes at least one radiating element 111. The phase shifter 13 is configured to perform beamforming on the antenna assembly 1. The switching assembly 12 is communicatively connected to the element group 11, and is configured to control on/off of the element group 11. When different element groups 11 are turned on, roll angles of the antenna assembly 1 are different. According to the solution provided in embodiments of this application, the roll angle of the antenna assembly 1 can be remotely adjusted via the switching assembly 12. Therefore, a mechanical adjustment structure of the antenna assembly 1 can be omitted, adjustment difficulty can be reduced, and an actual use requirement can be better met.

It should be noted that a part of this patent application document includes content protected by copyright. Except for making copies of patent documents or recorded content of patent documents in the China National Intellectual Property Administration, the copyright owner reserves the copyright.

1. An antenna assembly, comprising:
at least one element group, wherein each element group of the at least one element group comprises at least one radiating element;
a switching assembly communicatively connected to the at least one element group, and being configured to control turning on or off of the at least one element group; and
a phase shifter is communicatively connected to the switching assembly, and being configured to perform beamforming on the antenna assembly, wherein
in response to the switching assembly turning on different element groups of the at least one element group, roll angles of the antenna assembly are different.

2. The antenna assembly according to claim 1, further comprising:
a plurality of element groups, and each element group of the plurality of element groups is disposed in at least one of a length direction or a width direction of the antenna assembly.

3. The antenna assembly according to claim 2, wherein the plurality of element groups disposed along a straight line of the length direction of a same antenna assembly form a first radiation structure, and a plurality of first radiation structures are disposed along the width direction of the antenna assembly and separated from each other.

4. The antenna assembly according to claim 3, wherein adjacent first radiation structures of the plurality of first radiation structures along the length direction of the antenna assembly are separated by a preset distance.

5. The antenna assembly according to claim 2, wherein the plurality of element groups disposed along a straight line of the width direction of a same antenna assembly form a second radiation structure, and a plurality of second radiation structures are disposed along the length direction of the antenna assembly and separated from each other.

6. The antenna assembly according to claim 5, wherein adjacent second radiation structures of the plurality of second radiation structures along the width direction of the antenna assembly are separated by a preset distance.

7. The antenna assembly according to claim 2, further comprising:
a plurality of switching assemblies, and each switching assembly of the plurality of switching assemblies corresponds to the at least one element group, and is configured to control turning on or off of the corresponding element group of the at least one element group.

8. The antenna assembly according to claim 7, wherein at least one switching assembly of the plurality of switching assemblies is between adjacent element groups of the plurality of element groups along the length direction or the width direction of the antenna assembly.

9. The antenna assembly according to claim 1, further comprising at least one of:
a transmission part; or
a calibration network communicatively connected to the phase shifter.

10. A communication device, comprising:
an antenna assembly, wherein the antenna assembly comprises:
at least one element group, wherein each element group of the at least one element group comprises at least one radiating element;
a switching assembly communicatively connected to the at least one element group, and being configured to control turning on or off of the at least one element group; and
a phase shifter communicatively connected to the switching assembly, and being configured to perform beamforming on the antenna assembly, wherein
in response to the switching assembly turning on different element groups of the at least one element group, roll angles of the antenna assembly are different.

11. The communication device according to claim 10, wherein the antenna assembly comprises:
a plurality of element groups, and each element group of the plurality of element groups is disposed in at least one of a length direction or a width direction of the antenna assembly.

12. The communication device according to claim 11, wherein the plurality of element groups disposed along a straight line of the length direction of a same antenna assembly form a first radiation structure, and a plurality of first radiation structures are disposed along the width direction of the antenna assembly and separated from each other.

13. The communication device according to claim 12, wherein there is a preset distance between adjacent first radiation structures of the plurality of first radiation structures along the length direction of the antenna assembly are separated by a preset distance.

14. The communication device according to claim 13, wherein the plurality of element groups disposed along a straight line of the width direction of a same antenna assembly form a second radiation structure, and a plurality of second radiation structures are disposed along the length direction of the antenna assembly and separated from each other.

15. The communication device according to claim 14, wherein adjacent second radiation structures of the plurality of second radiation structures along the width direction of the antenna assembly are separated by a preset distance.

16. The communication device according to claim 11, wherein the antenna assembly comprises:
a plurality of switching assemblies, and each switching assembly of the plurality of switching assemblies corresponds to the at least one element group, and is configured to control turning on or off of the corresponding element group of the at least one element group.

17. The communication device according to claim 16, wherein the at least one switching assembly of the plurality of switching assemblies is between adjacent element groups of the plurality of element groups along the length direction or the width direction of the antenna assembly.

18. The communication device according to claim 10, wherein the antenna assembly further comprises at least one of:
a transmission part; or
a calibration network, communicatively connected to the phase shifter.
